(19) United States
(12) Patent Application Publication
(10) Pub. No.: US 2015/0379473 A1
(43) Pub. Date: Dec. 31, 2015

(54) SYSTEM AND METHODS FOR GENERATING RANKED JOB REFERRALS

(71) Applicant: Peercisely, Inc., Tiburon, CA (US)

(72) Inventor: Arek Sokol, Tiburon, CA (US)

(73) Assignee: Peercisely, Inc., Tiburon, CA (US)

(21) Appl. No.: 14/559,792

(22) Filed: Dec. 3, 2014

Related U.S. Application Data
(60) Provisional application No. 62/018,833, filed on Jun. 30, 2014.

(51) Int. Cl. G06Q 10/10; G06F 17/30

(52) U.S. Cl. CPC G06Q 10/1053; G06F 17/3053; G06F 17/30598

(57) ABSTRACT

A data record descriptive of an employment opportunity submitted by a potential employer is provided to multiple users. Referrals from at least several of these users are received, where the referrals indicating multiple candidates. Numeric metrics related to the referring registered users are retrieved from a database, including, for each referring registered user, (i) a first numeric metric indicative of success rate of past referrals submitted by the referring registered user and (ii) a second numeric metric indicative of quality of feedback related to the referring registered user. Respective scores for each of the candidates are calculated based at least on the received numeric metrics, the candidates are ranked based on the calculated scores to generate a ranked list, and a data record including the ranked list is provided to the potential employer.

### CROSS-REFERENCE TO RELATED APPLICATION

This application claims priority to U.S. Provisional Patent Application No. 62/018,833, filed on Jun. 30, 2014, and titled “Social media driven referral site for filling jobs submitted by companies that provides financial benefit to the referrer when a referral is interviewed satisfactorily and/or is hired,” the entire disclosure of which is hereby expressly incorporated by reference herein.

### FIELD OF TECHNOLOGY

This application generally relates to automatically generating metrics of compatibility between employment opportunities and users, and to using these metrics to automatically generate targeted referrals for employers.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

To find suitable candidates for job vacancies, employers either advertise using websites, social media, newspapers, etc., or using recruiting services. In general, advertising is not very efficient and requires that employers spend much time reviewing candidates, while recruiting services are expensive and limited in scope. Moreover, professional recruiters typically have little, if any, personal knowledge of the candidates they refer to employers.

### SUMMARY

A system of this disclosure can receive a description of an employment (or “job”) opportunity from a potential employer, provide the description to registered (and, in some cases, non-registered) users, receive referrals from at least some of the users, and automatically rank the referred potential candidates for review by the employer based on one or more quantitative metrics related to the referrers and/or the referred potential candidates. For example, a certain quantitative metric can relate to the success rate of a referrer, so that a referrer whose referrals have resulted in interviews and hiring decisions will have a higher metric than a referrer whose referrals have not resulted in interviews or hiring decisions. Thus, the system can rank a potential candidate referred by a successful referrer higher than another potential candidate referred by a less successful referrer. Further, once the potential candidate accepts the referral and becomes an actual candidate, the system can adjust the metric for a referrer in accordance with how far the referred candidate progressed with respect to a certain employment opportunity. Still further, to rank potential and actual candidates more accurately, the system in some cases can utilize candidate-specific metrics, such as an average rating assigned to the candidate from employers with whom the candidate previously interviewed, or a percentage of the match between the candidate's profile and the job as described by the employer (using tags for specific skills or years of experience, for example). Moreover, the system can allocate awards, such as points redeemable for money, products, or services, to successful referrers, as well as generate charitable contributions to qualifying organizations.

One embodiment of these techniques method for automatically generating ranked candidate referrals for employment opportunities, which can be carried out one or more processors. The method includes providing a data record that describes an employment opportunity, submitted by a potential employer, to registered users. The data record can be provide to the registered users via a communication network. Further, the method includes receiving referrals from at least several of the registered users to whom the data record was provided, where the referrals indicate several potential candidates. Still further, the method includes retrieving numeric metrics related to the referring registered users from an electronic database, which includes retrieving, for each referring registered user, (i) a first numeric metric indicative of success rate of past referrals submitted by the referring registered user and (ii) a second numeric metric indicative of quality of feedback related to the referring registered user. The method also includes calculating respective scores for each of the candidates based at least on the received numeric metrics, ranking the candidates based on the calculated scores to generate a ranked list, and providing the data record including the ranked list to the potential employer.

### BRIEF DESCRIPTION OF THE DRAWINGS

FIG. 1 is a block diagram of an example computing system in which techniques for automatic ranking of candidates based on quantitative metrics related to referrers can be implemented;

FIG. 2 schematically illustrates example user interface and system functions along with example data flow between the functions, which can be implemented in the system of FIG. 1;

FIG. 3 is a flow diagram of an example method for generating a ranked list of candidates based on users' referrals, which can be implemented in the system of FIG. 1;

FIG. 4 is a flow diagram of an example method for calculating a score for a candidate based on several quantitative metrics, which can be implemented in the system of FIG. 1;

FIG. 5 is a flow diagram of an example method for generating a ranked list of candidates using the method of FIG. 4 or a similar method to generate scores for individual candidates;

FIG. 6 is a flow diagram of an example method for updating one or several quantitative metrics for a user based on feedback received in connection with a candidate referral, which also can be implemented in the system of FIG. 1; and

FIG. 7 is a combined block/data flow diagram that illustrates example updates to referrer, referral, and employer rating, which can take place in the system of FIG. 1 during operation.

### DETAILED DESCRIPTION

### Overview

Generally speaking, a computer-based referral system operating in a communication network facilitates efficient exchange of information regarding employment opportunities between potential employers, “social” referrers, and potential candidates. Social referrers (referred to below simply as “referrers”) can include people who are not professional recruiters or firms that specialize in placement, but rather are individuals who may refer their colleagues or friends to potential employers based on their personal knowledge of potential candidates. As discussed in more detail below, the referral system can generate quantitative metrics for social referrers based on, for example, how far their referrals progress, how many successful referrals they submit, how potential employers rank referred candidates, etc. The referral system then can use these metrics to rank candidates for a potential employer, thereby improving the probability that the potential employer will quickly find a good match for the employment vacancy. As also discussed below, the referral system can automatically incentivize social referrers by allocating awards to successful referrers.

The referral system can implement respective user interface (UI) views for employers, social referrers, candidates, and operators who may monitor the exchange of information via referral system. Using employer UI, employers can submit job descriptions, review referrals and referrers, record interviewing and hiring decisions, submit payments, etc. Referrers can utilize referrer UI to view new job postings, view their feedback and various quantitative metrics, check their awards, etc. Potential candidates can use candidate UI to view job opportunities for which they were referred, accept or decline invitations to interview, etc. Potential candidates who accept referrals and agree to being considered for job opportunities become actual candidates (unless explicitly qualified, the term “candidate” in this document can refer to a potential candidate or an actual candidate, depending on whether or not the candidate has already expressed interest in the job). Operators can use operator UI to modify or remove listings. In some cases, users can have multiple roles and accordingly can access multiple UI views, such as referrer UI and candidate UI.

In an example scenario, a hiring manager at a company that develops video games submits a description of a new job opportunity of the referral system. The description specifies the title, the location, the required skills and experience level, the category (e.g., “software development”) and one or several sub-categories (e.g., “embedded”) to which the job opportunity belongs, etc. In one implementation of the referral system, the hiring manager specifies some of these parameters using selectable tags or keywords. The referral system stores the description in an electronic database and makes the corresponding data record available to social referrers.

Social referrers, Alice, Bob, Carl, Dana, and Ed take notice of the new job opportunity when they access the referral system and forward the job description to potential candidates using electronic mail or social media, for example. In particular, Alice has referred Fiona, Bob has referred George, both Carl and Dana have referred Helen, and Ed has referred John. Potential candidates Fiona, George, Helen, and John receive notifications and, upon reviewing the job description, only George, Helen, and John express interest by operating appropriate controls embedded in the message describing the job opportunity, by directly accessing the referral system via a web interface, or in another suitable manner.

The referral system receives indications that George, Helen, and John have expressed interest in the job opportunity and now are potential candidates. The referral system retrieves the overall rating, a description of referral history, and possibly other quantitative metrics for the corresponding referrers Bob, Carl, Dana, and Ed and calculates scores for each of the candidates. In addition to metrics related to individual referrers, the referral system retrieves multipliers specific to the software industry and, in this particular case, also to the specific area of embedded software development.

As a more specific example, the referral system calculates the score of 0.8 for George based in part on the personal rating of the corresponding referrer Bob and the history of Bob's previous referrals. Although each of Helen's referrers, Carl and Dana, has lower individual metrics than Bob, the referral system calculates a higher score of 0.85 for Helen because (i) Helen has two referrers rather than one, and (ii) in the past, Carl (one of her referrers) successfully referred a candidate in the software industry. The referral system calculates the score of 0.7 for John based on the metrics of the corresponding referrer Ed.

The referral system then ranks the candidates George, Helen, and John to generate a ranked list {Helen, George, John}. The referral system then provides the ranked list to the hiring manager, who considers candidates in the order of the ranking. The hiring manager first uses the employer UI to assign preliminary scores to each of Helen, George, and John. She decides to interview only Helen and George, uses the employer UI to indicate that each of Helen and George is interviewing, and the referral system accordingly updates scores for Helen and George. After interviewing both candidates, she decides to hire George, and again uses the employer UI to indicate that Helen's candidacy ultimately has been rejected, and that an offer of employment was extended to George. In view of the indications, the referral system allocates a relatively large number of points to Bob (who referred the successful candidate George), a smaller number of points to Carl and Dana (who referred Helen), and a relatively small number of points to Bob (who referred George). Further, the referral system updates the quantitative metrics for the referrers in view of the preliminary scores from the hiring manager and the progress of their corresponding referrals.

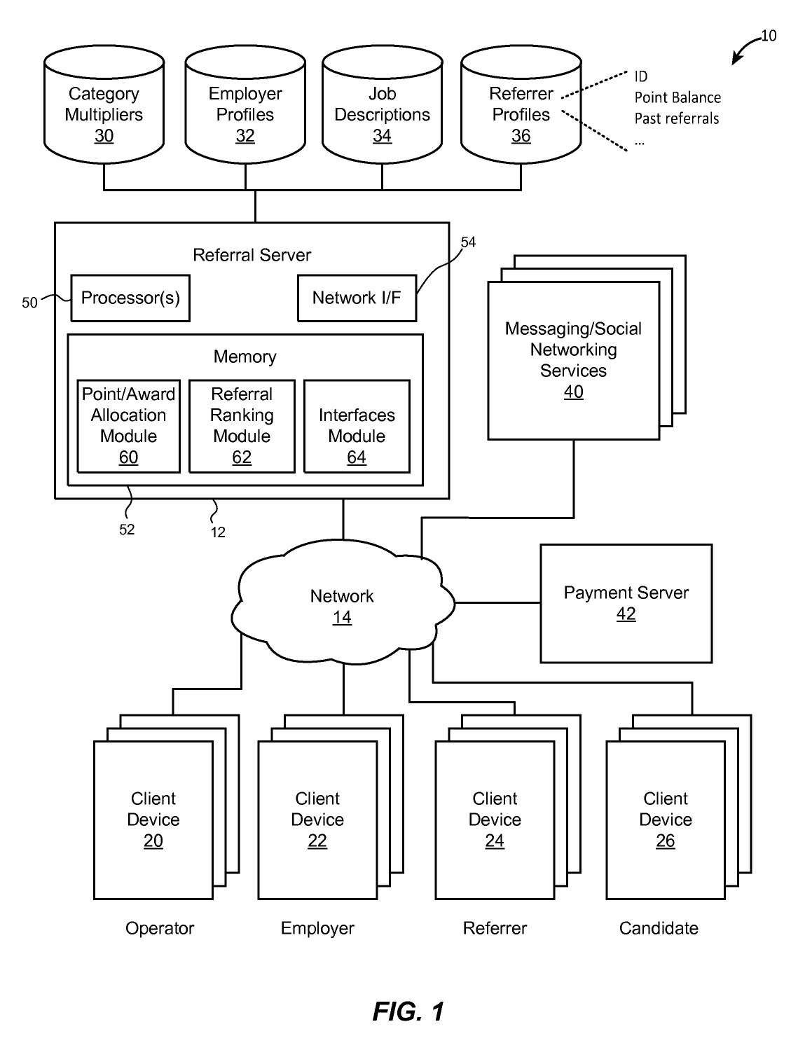

An example implementation of the referral system is discussed next with reference to FIG. 1.

### Example Referral System

Referring to FIG. 1, an example system 10 includes a referral server 12 which operators, employers, referrers, and candidates can access via a communication network 14 using computing devices 20, 22, 24, and 26, respectively. The referral server 12 can be communicatively coupled to a category multipliers database 30 that stores multiplier values for industry categories and sub-categories, an employer profile database 32 that stores information regarding various employers who use the referral service, a job descriptions database 34 that stores titles, locations, categories, salary expectations, and other information about jobs submitted by employers, and a referrer profile database 36 that stores identities, indications of industry categories and sub-categories to which the referrer belongs, award point balance, past referral history, and other data for individual referrers.

Each of the databases 30-36 can be implemented on a non-transitory computer-readable medium such as one or several hard disks, for example. Depending on the implementation, the databases 30-36 can reside in different storage devices or shared storage devices. The databases 30-36 can be implemented can be implemented as relational databases made up of logically interconnected tables, for example, or in any suitable manner.

The referral server 12 and the client devices 20-26 also can access messaging/online social networking services 40 that can include email services, interest, location and/or photo sharing services, professional network services, or any other services via which referrers can communicate with candidates. Further, the referral server 12 and the client devices 20-26 can access a payment service 42 to exchange money for submitting new job descriptions, receiving ranked referrals, allocating and receiving awards, etc.

Any suitable number of computing devices 20-26 of any suitable type can operate in the system 10. For example, the computing devices 20-26 can include personal desktop computers, laptop computers, tablet computers, smartphones, etc. The computing devices 20-26 can include processors, memory, and user interface components to run web browsing applications or special-purpose applications for accessing the referral service.

As illustrated in FIG. 1, the referral server 12 can include one or several processors 50 and non-transitory memory 52 readable by one or several processors 50. The referral server 12 can be implemented in a single server device or multiple devices using any suitable server topology. The memory 52 can store instructions that execute on the one or several processors 50, in any suitable format. These instructions can implement, among other components, a point/award allocation module 60 that determines how points and/or money should be allocated in view of referral progress and employer feedback, a referral ranking module 62 that automatically determines how referrals should be ranked, and an interfaces module 64 that provides operator UI, employer UI, referrer UI, and candidate UI.

In some implementations, instead of one or more processors coupled to a memory, the referral server 12 can include modules that are functionally similar to the modules 60, 62, and 64 but are implemented using field programmable gate array (FPGA) or an application-specific integrated circuit (ASIC) components, for example. As another example, some of the functionality of the modules 60, 62, and 64 can be implemented in firmware. More generally, the referral server 12 can include any suitable processing hardware configured to implement the techniques of this disclosure.

The referral server 12 also can include a network interface 54 for exchanging data with remote devices via the communication network 14 and/or other communication network. The network interface 54 can support wired and/or wireless communications, and can operate using any set of suitable communication protocols, such as TCP/IP, IEEE 802.11 (“WiFi®”), etc.

### Example UI and System Functions

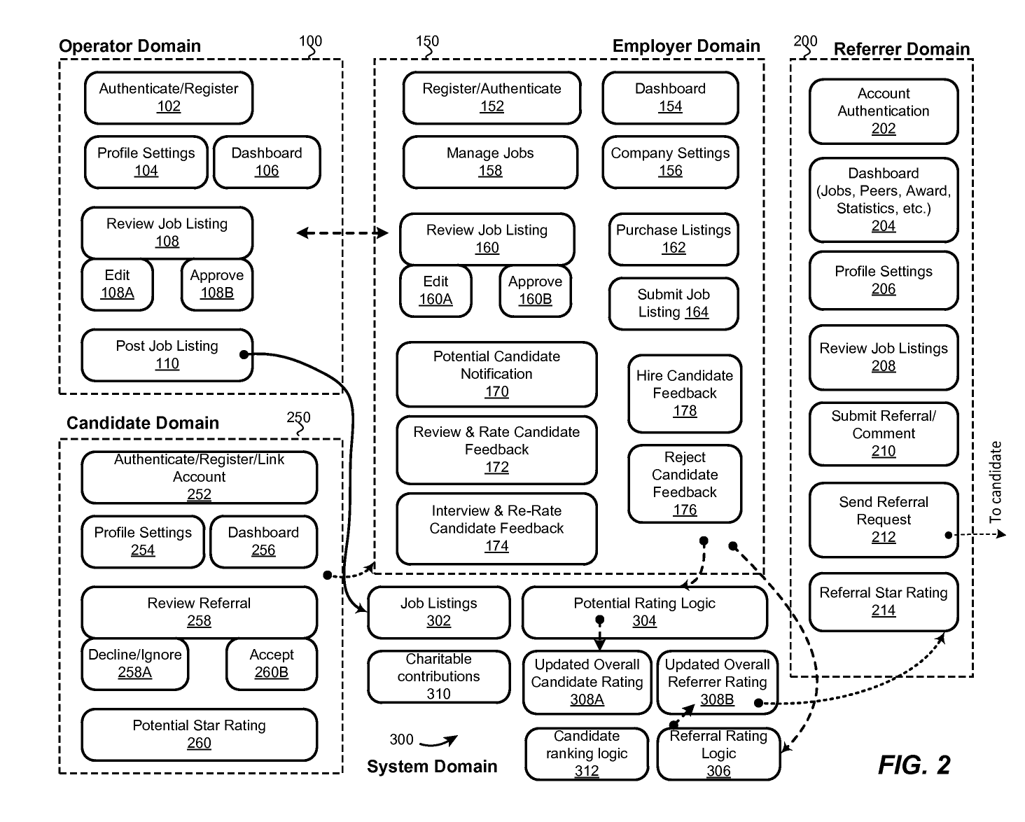

Next, FIG. 2 illustrates some of the example UI and system functions that can be implemented in the referral system 10. For clarity, operator UI functions as illustrated as part of an operator domain 100, employer UI functions as illustrated as part of an employer domain 150, referrer UI functions as illustrated as part of a referrer domain 200, candidate UI functions as illustrated as part of a candidate domain 250, and system functions are illustrated as part of a system domain 300. The interfaces module 64 (see FIG. 1) can implement UI functions in the domains 100, 150, 200, and 250, for example, and the point/award allocation module 60 and/or the referral ranking module 62 can implement the functions in the domain 300. For simplicity, FIG. 2 depicts only some of the data flow between the functions of FIG. 2.

The operator domain 100 can provide an authentication/registration function 102 to allow only properly authorized operators to access the referral system, a profile setting function 104 to configure operator-specific parameters (e.g., one or several industries for which the particular operator is responsible), and a dashboard function 106 via which the operator can view new submissions from employers, for example, and access other operator functions. More particularly, the operator can use a review function 108 to view a job listing in detail and edit the listing using an edit function 108A or approve the listing using an approve function 108B. The operator then can use a post job listing function 110 to create a new data record including the description of the job listing as a part of a job listing 302 (which can be stored in the job descriptions database 34 illustrated in FIG. 1).

In the employer domain 150, a registration/authentication function 152 prevents unauthorized submissions or access to job data. Each employer can have access to its own dashboard via a dashboard function 154 for submitting new job descriptions, reviewing referrals, providing feedback, etc. In particular, an employer can manage company settings (e.g., category listing, limits on the number or type of referrals, etc.) via a company settings function 156 and can re-list, expire, update, and otherwise manage already-submitted job descriptions using a manage jobs function 158. Thus, the employer can purchase new job listings using a purchase listings functions 162, use a review job listing function 160 to edit a job listing (function 160A) and approve the job listing (function 160B), and submit a new job listing using a submit job listing function 164. Referring back to FIG. 1, the purchase listings functions 162 can direct the employer to the payment service 42 for paying for an individual listing or a certain number of listings, depending on the arrangement with the operator of the referral system. In one example implementation, the job listing function 164 generates a payment contingent on whether the referral system provides referrals to employers.

The employer can be notified of a new referral via the potential candidate notification function 170, review and provide initial feedback via the use review and rate candidate feedback function 172, and, if the employer goes forward with the interviewing process, provide further feedback via the interview and re-rating feedback function 174. The employer can provide further feedback using the rejected candidate feedback function 176 and hired candidate feedback function 178 when the employer rejects or hires the candidate, respectively, after the interview.

With continued reference to FIG. 2, the referrer domain 200 can include the account authentication function 202 to prevent unauthorized social referrers from accessing the referral system. However, in some implementations of the referral system, unauthorized social referrers are permitted to view job listings and/or access a certain limited subset of the functions in the referrer domain 200. The referrer domain 200 also can include the dashboard function 204 to provide a social referrer with access to new job listings, previous referrals, point balance, etc., and the profile setting function 206 for specifying various user-specific parameters and preference such as the professional or academic credentials of the social referrers, notification preferences, etc. Further, in some implementations, the referrer can use the profile setting function 206 to specify his or her industry category and/or one or more sub-categories. In some implementations, an operator may be able to override the category and/or one or more sub-categories for the referrer upon verifying the referrer's profile, for example, to prevent referrers from overstating their insight or credentials.

The dashboard function 204 can provide access to, among other functions, the review a job listing function 208 using which a social referrer can access new job listings submitted by employers, the submit referral/comment function 210 for specifying the name of a potential candidate to the referral system, and the send referral request function 212 for forwarding the job description along with a recommendation to apply for the job to a candidate. In one example implementation, the send referral request function 212 utilizes Application Programming Interfaces (APIs) of messaging and/or social network services to forward the referral. For example, the send referral request function 212 can invoke appropriate APIs to generate data records describing job referrals via such services as Twitter®, Facebook®, Google Plus®, LinkedIn®, etc.

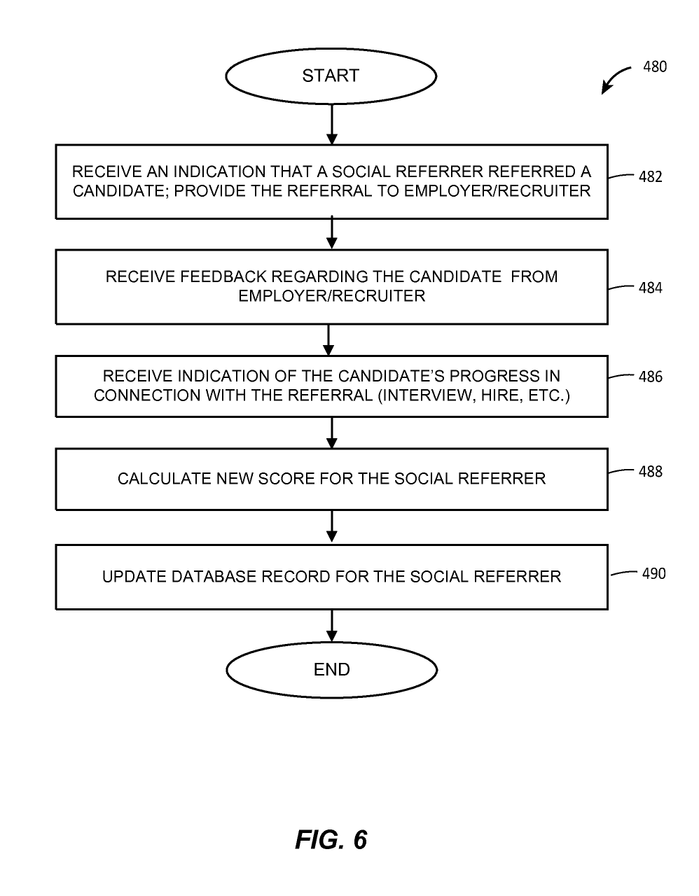

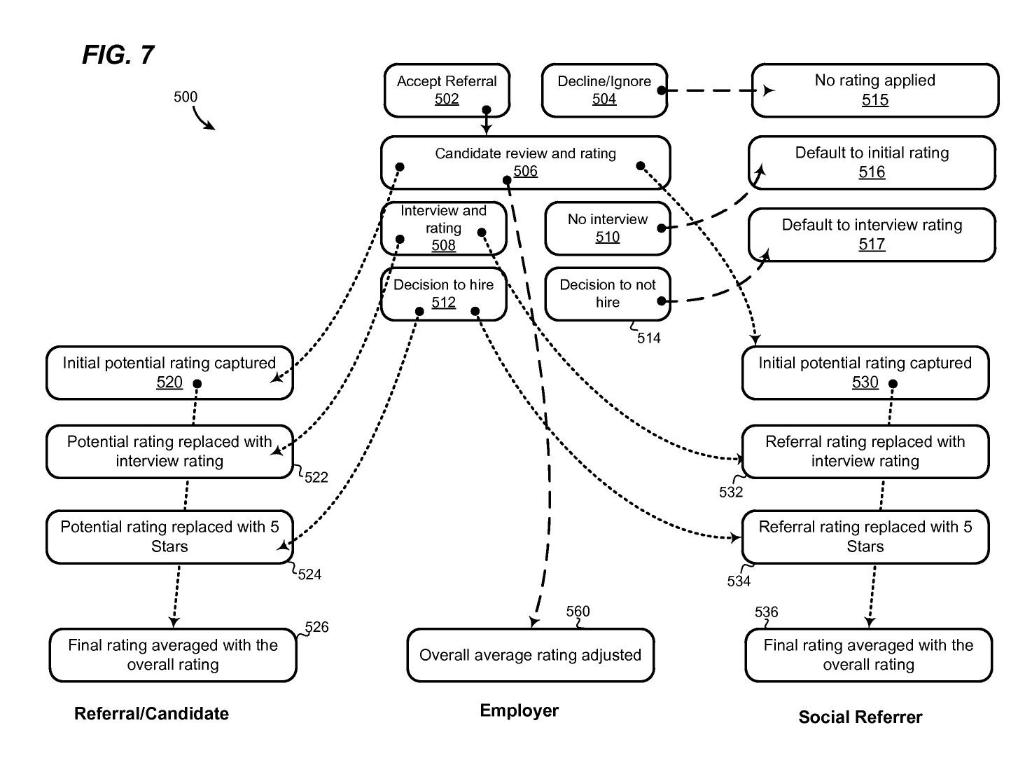

Further, the referral domain 200 can include the referral star rating function 214 for generating and displaying to the social referrer his or her star rating, or any other suitable metric of the quality of the social referrer's submissions. The referral star rating function 214 is discussed in more detail with reference to FIGS. 6 and 7.

Still referring to FIG. 2, the candidate domain 250 can include the function 252 for authenticating an already-registered candidate, setting up an account of a new candidate, link the candidate's social networking service account with an account a referral service account, etc. The candidate domain 250 also can include the profile setting function 254 for configuring candidate-specific parameters and preferences, a dashboard function 256 for viewing jobs for which the candidate has been referred, other jobs, past referrals, past interviews and job offers, etc. The candidate can operate a review referral function 258 to respond to a notification of a recent referral by declining the referral (function 258A) or accepting the referral (function 258B). Further, the candidate domain 250 can include a potential star rating function 260 for generating and displaying to the candidate his or her star rating. This function is discussed in more detail with reference to FIG. 7.

As indicated above, the functions in the system domain 300 can be implemented in, for example, the point/award allocation module 60 and/or the referral ranking module 62 illustrated in FIG. 1. These functions can include a job listing management function 302 for creating new data records describing job opportunities in a database, such as the database 34; a potential rating function 304 to assign the initial rating to a rating, in terms of star or using another metric; a referral rating function 306 to generate metrics for a social referrer based on the feedback regarding the referral and the reported progress of the candidate; an updated average overall rating function 308 to adjust the overall rating of a social referrer; a charitable contributions function 310 to control allocation of money or other gifts to charities; and a candidate ranking logic 312 to generate ranked list of candidates.

In operation, functions in the domains 100, 150, 200, 250, and 300 can exchange information. To this end, the module illustrated in FIG. 2 any suitable intra-process communication (IPC) schemes and/or inter-device messaging protocols can be used, on any suitable software platform. In the discussion below, the terms “message” and “notification” are used interchangeably. Data flow between functions is briefly discussed next. To avoid clutter, only some of the data flow is schematically illustrated with arrows in FIG. 2.

Functions in the employer domain 150 can interact with functions in the operator domain 150 to create operator-approved job listings. For example, in response to the employer operating the review job listing function 160, the referral system can automatically forward the appropriate notification to the review job listing function 108 in the operator domain 100; and, in response to the operator approving the listing, the review job listing function 108 can automatically forward the notification to the review job listing function 160. When the employer operates the post the job listing function 110, which can trigger a message to the job listing function 302, which in turns saves the new data record including the job description in the database.

In response to appropriate input from a candidate, the review referral function 258 generates a message to the potential candidate notification function 170 in the employer domain 150. When the employer operates the feedback functions 172 and 174, the referral system generates appropriate notifications and forwards the notifications to the potential rating logic 304 and eventually to the updated overall candidate rating module 308A to generate a new rating of the candidate. The referral system also forwards notifications to the updated overall referrer rating module 308B to generate a new rating of the social referrer.

As another example of interaction between the functions of FIG. 2, when the social referrer operates the send referral request function 212, the referral system generates an appropriate notification and forwards the notification to the review referral function 258. Moreover, the referral system can invoke one or several APIs to forward the notification to the candidate via email, short message services, chat services, social networking services such as Twitter®, Facebook®, Google Plus®, LinkedIn®, etc.

As yet another example, the candidate ranking logic 312 can receive messages indicating candidates and the corresponding social referrers from functions 210 and 258. The candidate ranking logic 312 also can invoke APIs for accessing databases, such as the databases 30-36 depicted in FIG. 1, to retrieve referrer parameters, candidate parameters, and industry parameters when ranking candidates.

### Example Methods for Ranking Candidates

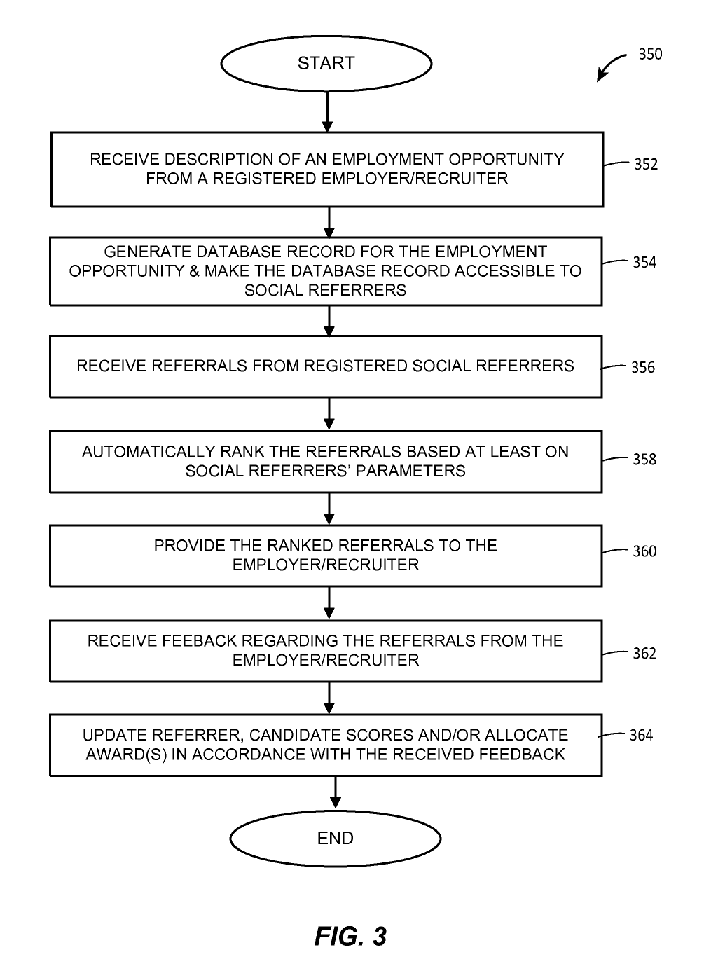

Next, several example methods that can be implemented in the referral system of FIG. 1 are discussed with reference to FIGS. 3-6. Each of these methods can be implemented as a set of instructions stored on a computer-readable memory and executable on one or more processors, for example.

Referring first to FIG. 3, a method 350 for generating a ranked list of candidates based on users' referrals can be implemented in the referral ranking module 62, for example, or another component or a set of components of the referral system of FIG. 1. For additional clarity, the method 350 is discussed also with reference to FIG. 2, where the functions of a referral system are illustrated in more detail.

The method 350 begins at block 352, where a description of an employment opportunity, or simply a job, is received from a registered employer or a recruiter. In some cases, non-registered employers or recruiters can be allowed to use the referral service of this disclosure; however, non-registered employers or recruiters may not be able to access all of the available functionality of the referral service. The description of the employment opportunity can be a data record that includes, for example, a job title, one or more categories to which the job belongs and, in some cases, one or more sub-categories, an indication of the geographic location, a list of requirements, an indication of required experience, etc. The functions 158-164 of FIG. 2 can generate and populate the data record in conformance to a certain format supported by the referral system, for example. Prior to specifying the parameters of the new employment opportunity, the operator may have invoked the purchase listing function 162, depending on the implementation and/or scenario.

Next, a database record including the new job description is created at block 354. The database record is made accessible to social referrers or certain subsets of the social referrers. For example, upon request from the employer, the referral system may expose a certain job listing to only those referrers who have been highly successful at referring candidates in the past, or to only those referrers who have proven to have access to certain relevant industries. Functions invoked at block 354 can include the review job listing function 108 and the post job listing function 110 in the operator domain 100, the job listing functions 302 and other functions in the system domain 300 to make the new job listing accessible to social referrers via the dashboard function 204 in the referrer domain 200, etc.

At block 356, one or several referrals from registered social referrers are received. As discussed above, non-registered users in some cases also may act as social referrers, but their access to the functionality of the referral system may be limited. Block 356 can involve execution of functions 208-212, for example. Each referral received at block 356 can be a data record that at least identifies the employment opportunity, the candidate and the corresponding social referrer. In some implementations, referrals from social referrers whose overall rating is below a certain threshold number are discarded. In this manner, the referral system can prevent referrers from flooding the system with duplicate referrals or inappropriate referrals, for example.

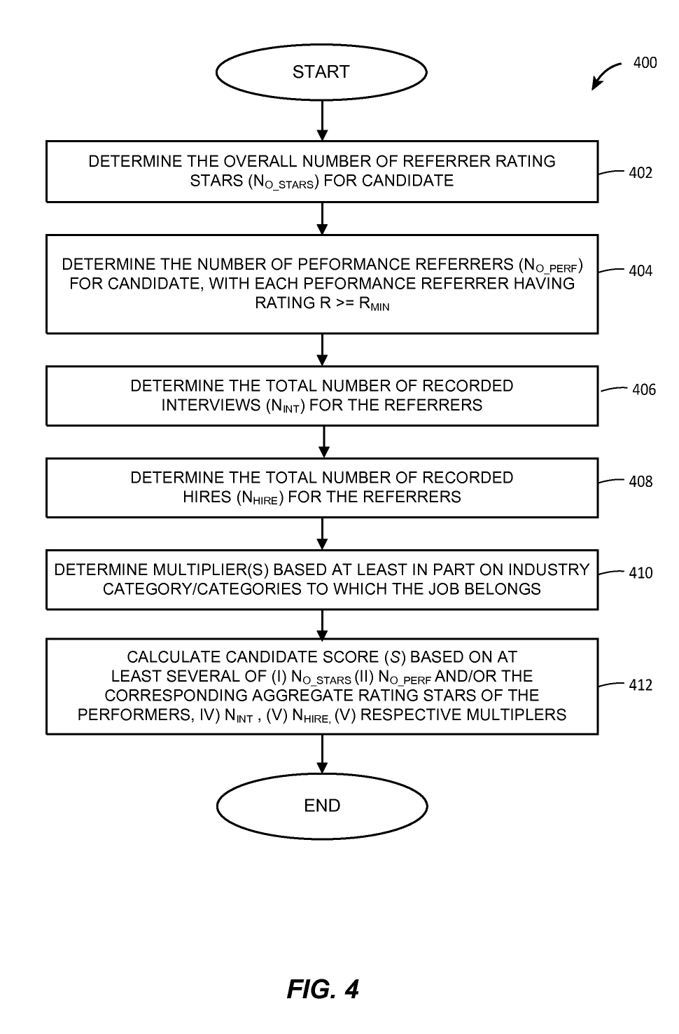

At block 358, the referrals are automatically ranked based on the parameters of the social referrer and, in some cases, the available parameters of the candidate. To this end, the referral system can execute the candidate ranking logic 312, for example. Referral ranking is discussed in more detail with reference to FIG. 4.

With continued reference to FIG. 3, a list of ranked referrals is provided to the employer or recruiter at block 360. In an example implementation, the employer views the referrals using the function 172. The list of ranked referrals can conform to any suitable format, such as one in which the candidates are listed in the descending order of the preliminary scores assigned by the candidate ranking logic 312, with each entry including the name of the candidate, the name of the corresponding one or several referrers, the score assigned by the candidate ranking logic 312, and a link to the candidate's profile information (including the resume, the cover letter, etc.). In one implementation, the referral system provides a list of no more than N candidates, where N is any suitable number such as 3, 5, or 7, for example. Thus, when a large number of referrals is received, the referral system can omit from the list those referrals that are unlikely to yield the decision to hire.

Next, feedback regarding the candidates is received at block 362. More particularly, the functions 172-178 can generate feedback of different types and forward the feedback to the functions 304, 306, 308A, and 308B. The feedback can include quantitative metrics (e.g., “upon initial review, the candidate is assigned the score of 7 out of 10” or “the interviewee's communication skills are assigned the score of “4 out of 5”) as well non-quantitative comments, depending on the implementation or scenario. Feedback is discussed in more detail below with reference to FIG. 7.

At block 364, the functions 304, 306, 308A, and 308B can update referrer-specific and candidate-specific quantitative metrics. For example, a certain referrer's overall score can go up from 7.5 to 8.1 after she referred a candidate whom the employer decided to interview but ultimately declined to hire, and the candidate's overall score can go from “unavailable” to 4.0. The updated values of quantitative metrics can be stored in the database 36, for example. Financial awards and/or charitable contributions also can be allocated at block 364.

Now referring to FIG. 4, an example method 400 for calculating a score for a candidate based on several quantitative metrics can be implemented in the referral ranking module 62 of FIG. 1 and/or as part of the candidate ranking logic 312 of FIG. 2. The method 400 can be executed for each candidate referred for a certain employment opportunity. For example, referring back to FIG. 3, six referrals naming four different candidates can be received at block 356, and the method 400 can be executed once for each of the four candidates, at block 358. The employment opportunity can correspond to a certain category (e.g., “accounting”) and a sub-category (“corporate”), in at least some of the cases.

In the example implementation discussed with reference to FIG. 4, the rating is expressed as a certain number of stars, so that a well-performing referrer can be assigned a five-star rating while a referrer performing relatively poorly can be assigned only two stars, for example. Depending on the particular implementation, the rating can be defined on a discrete scale only or on a fractional scale. More generally, however, the rating can be a quantitative metric indicative of the referrer's past success with referring candidates.

At block 402, the overall number of referring rating stars N_{O}_{_{—}}_{STARS} is determined. For example, the overall number of referrers N_{O}_{_{—}}_{REF} for the candidate can be determined, and the sum of respective star ratings of these referrers can be calculated as:

$${N}_{O\_STARS} = {\sum }_{i}^{{N}_{REF}} {Rating}_{i} \qquad ( Eq . 1 )$$

In other implementations, similar factors can be used. For example, an average star rating can be used as a factor rather than the overall total of stars.

At block 404, the number of “performance” referrers N_{O}_{_{—}}_{PERF} is determined, where each performance referrer has a rating R that exceeds a certain predefined threshold R_{MIN}, such as 4 stars out of 5, i.e., R_{MIN}≧4.0. Further, in some implementations, the number N_{C}_{_{—}}_{PERF} of “category performers,” or referrers whose average star rating specifically for the category to which the job opportunity belongs exceeds R_{MIN}, can be calculated. Still further, the number N_{SC}_{_{—}}_{PERF} of “sub-category performers,” or referrers whose average star rating specifically for the sub-category exceeds R_{MIN}, also can be calculated, in some implementations. Thus, a certain referrer may be an overall performer, but her referrals so far have been for jobs in categories different from the category of the vacant job. As a result, a referral from this overall performer would contribute to number N_{O}_{_{—}}_{PERF} but not contribute to numbers N_{C}_{_{—}}_{PERF} or N_{SC}_{_{—}}_{PERF}.

In some embodiments, the numbers of category and sub-category performer rating stars N_{C}_{_{—}}_{STARS} and N_{SC}_{_{—}}_{STARS}, respectively, can be determined at block 404. More particularly, the number N_{C}_{_{—}}_{STARS} can correspond to the total number of stars of the referrers calculated only over those of the past referrals that belong to the same category as the vacant job, and the number N_{SC}_{_{—}}_{STARS} can correspond to the total number of stars of the referrers calculated only over those of the past referrals that belong to the same sub-category as the vacant job. Thus, the metrics N_{O}_{_{—}}_{STARS}, N_{C}_{_{—}}_{STARS} and N_{SC}_{_{—}}_{STARS} are aggregate rating metrics calculated over sets of referrers.

Next, at block 406, the total of number of recorded interviews N_{O}_{_{—}}_{INT} credited to the referrer(s) is determined. To continue with the example in which two referrers refer the same candidate, the first referrer may have previously submitted referrals that yielded two interviews, and the second referrer may have previously submitted referrals that yielded one interview, so that N_{O}_{_{—}}_{INT}=2+1=3. In some implementations, the total of number of recorded interviews N_{C}_{_{—}}_{INT} credited to the referrer(s) for the referrals within the category to which the vacant job belongs, and the total of number of recorded interviews N_{SC}_{_{—}}_{INT} credited to the referrer(s) for the referrals within the sub-category to which the vacant job belongs, are determined.

At block 408, the total number of hires N_{O}_{_{—}}_{HIRE} credited to the referrer(s) is determined. The number of hires N_{C}_{_{—}}_{HIRE} credited to the referrer(s) for referrals within the category to which the vacant job belongs, and the number of hires N_{SC}_{_{—}}_{HIRE} credited to the referrer(s) for referrals within the category to which the vacant job belongs, also can be determined, in some implementations of FIG. 4.

At block 410, multipliers including industry category-specific multipliers are retrieved. For example, multiplier M_{O}_{_{—}}_{REF} can be used to weigh the overall importance of referring registered users (relative to tag-based profile matching, for example, as discussed below), multiplier M_{C}_{_{—}}_{REF} can be used to weigh the importance of referring registered users for the appropriate category, multiplier M_{SC}_{_{—}}_{REF} can be used to weigh the importance of referring registered users for the appropriate sub-category, multiplier M_{PERF} can be used to weigh the importance of highly rated referrers relative to other referrers, multiplier M_{INT} can be used to weigh the importance of past interviews resulting from referrals by referring registered users, and multiplier M_{HIRE} can be used to weigh the importance of past hires resulting from referrals by referring registered users. It is noted that some of these multipliers are specific to the industry category and, in some cases, a sub-category, while other multipliers are independent of categories or sub-categories. In general, any number of industry categories at any suitable number of tiers can be used. Different multiplier values can be stored in the category multiplier database 30, for example. In some implementations, the referral system can dynamically adjust multiplier values based on employer feedback, for example.

In an example implementation, the following values are assigned to multipliers:

TABLE 1

| Multiplier | Value |
|---|---|
| M_{O}_{_{—}}_{REF} | 1.00 |
| M_{c}_{_{—}}_{REF} | 2.00 |
| M_{SC}_{_{—}}_{REF} | 4.00 |
| M_{PERF} | 50.00 |
| M_{INT} | 25.00 |
| M_{HIRE} | 100.00 |

Referring still to FIG. 4, the flow then proceeds to block 412, where a score Sᵢ for candidate i is calculated based at least in part on the factors determines at blocks 402-410. In an example implementation, the score is calculated using the formulas below:

Sᵢ_{_{—}}_{O}=M_{O}_{_{—}}_{REF}(N_{O}_{_{—}}_{STARS}+M_{INT}N_{O}_{_{—}}_{INT}+M_{HIRE}N_{O}_{_{—}}_{HIRE}+M_{PERF}N_{O}_{_{—}}_{PERF}) (Eq. 2)

where Sᵢ_{_{—}}_{O} is the overall sub-score for candidate i;

Sᵢ_{_{—}}_{C}=M_{C}_{_{—}}_{REF}(N_{C}_{_{—}}_{STARS}+M_{INT}N_{C}_{_{—}}_{INT}+M_{HIRE}N_{C}_{_{—}}_{HIRE}+M_{PERF}N_{C}_{_{—}}_{PERF}) (Eq. 3),

where Sᵢ_{_{—}}_{C} is the category sub-score for candidate i;

Sᵢ_{_{—}}_{SC}=M_{SC}_{_{—}}_{REF}(N_{C}_{_{—}}_{STARS}+M_{INT}N_{SC}_{_{—}}_{INT}+M_{HIRE}N_{SC}_{_{—}}_{HIRE}+M_{PERF}N_{SC}_{_{—}}_{PERF}) (Eq. 4),

where Sᵢ_{_{—}}_{SC} is the overall sub-score for candidate i;

Sᵢ=Sᵢ_{_{—}}_{O}+Sᵢ_{_{—}}_{C}+Sᵢ_{_{—}}_{SC} (Eq. 5).

By way of further illustration, Table 2 below lists examples values that can be used in generating a score Sᵢ using Equations 2-5 illustrated above (along with several averages provided for clarity):

TABLE 2

| | Value for | Value for |
|---|---|---|
| Factor | Candidate A | Candidate B |
| Total Overall Referrers | 8 | 12 |
| Total Overall Rating Stars | 28 | 40 |
| Average Overall Star Rating | 3.5 | 3.33 |
| Total Overall Interviews | 12 | 10 |
| Total Overall Hires | 5 | 5 |
| Total Overall Performers | 6 | 6 |
| Total Category Performers | 4 | 8 |
| Total Category Performer | 16 | 32 |
| Rating Stars | | |
| Average Category Performer | 4.0 | 4.0 |
| Rating | | |
| Total Category Interviews | 10 | 8 |
| Total Category Hires | 4 | 4 |
| Total Sub-category Performers | 2 | 4 |
| Total Sub-category Performer | 9 | 20 |
| Rating Stars | | |
| Average Sub-category | 4.5 | 5.0 |
| Performer Rating | | |
| Total Sub-category Interviews | 5 | 5 |
| Total Sub-category Hires | 2 | 2 |
| Overall Sub-score | 1128 | 1090 |
| Category sub-score | 1732 | 2064 |
| Sub-category sub-score | 1736 | 2180 |
| Total | 4596 | 5334 |

Thus, in this example, the score S_{A} for candidate A is 4596, and the score S_{B} for candidate B is 5334, and the referral system accordingly can rank candidate B above candidate A when presenting referrals to the employer.

In other implementations, different and/or additional factors can be used to calculate referrer scores. For example, referrers who work or have worked in the same industry category and/or the sub-category can be identified. For these referrers, the number of stars can be calculated and used as a factor with a corresponding multiplier, the number of interviews can be calculated and used as a factor with a corresponding multiplier, the number of hires can be calculated and used as a factor with a corresponding multiplier, etc.

Further, in some implementations, a separately configurable multiplier can be used to weigh the overall importance of referring registered users relative to tag-based profile matching, for example. Still further, the score in some implementations can be based further on a quantitative metric indicative of how well the candidate's profile matches the job description. For example, an electronic database can store a profile for the registered candidate, including a listing of pre-defined tags such as “programming,” “Object Oriented,” Ruby on Rails,” etc. A job description can include a listing of tags selected from the same predefined pool, so that the number of matching tags can be compared to the overall number of tags included in the job description to generate a match metric. Also, multipliers alternatively or additionally can be used to weigh the importance of certain factors for a particular industry. As a more specific example, multipliers for a certain industry can weigh the number of referrers relatively high as compared to the number of hiring decision resulting from the referrers' submissions.

Other factors that can be used to adjust candidate scores can include measurements of referrer-candidate relationship as well as past employment metrics for potential or actual candidates. More particularly, the referral system can calculate a score for a candidate further in view of employment timeline overlap at the same employer, i.e., the amount of time during which both the candidate and the referrer worked for the same employer. Further, in addition to determining whether the referrer and candidate belong to the same category or sub-category, the referral system can use tags, resume keywords, etc. to assess the degree to which the referrer's skills and competencies overlap with the candidate's referrer's skills and competencies, as referrers with similar skills in general are more likely to competently judge their colleagues' abilities. Moreover, scores from such online services as Klout® can be used to factor in perceived influence, industry expertise, and credibility.

Examples of past employment metrics for candidates can include indications of past interview performance, indications of how well the candidate performed when seeking “tough-to-land” jobs (to compare with other candidates applying for the same job), longer-term employee performance and retention feedback metrics from former employer connections through the referral services, etc.

Conversely, some of the factors discussed above with reference to FIG. 4 can be omitted in some embodiments.

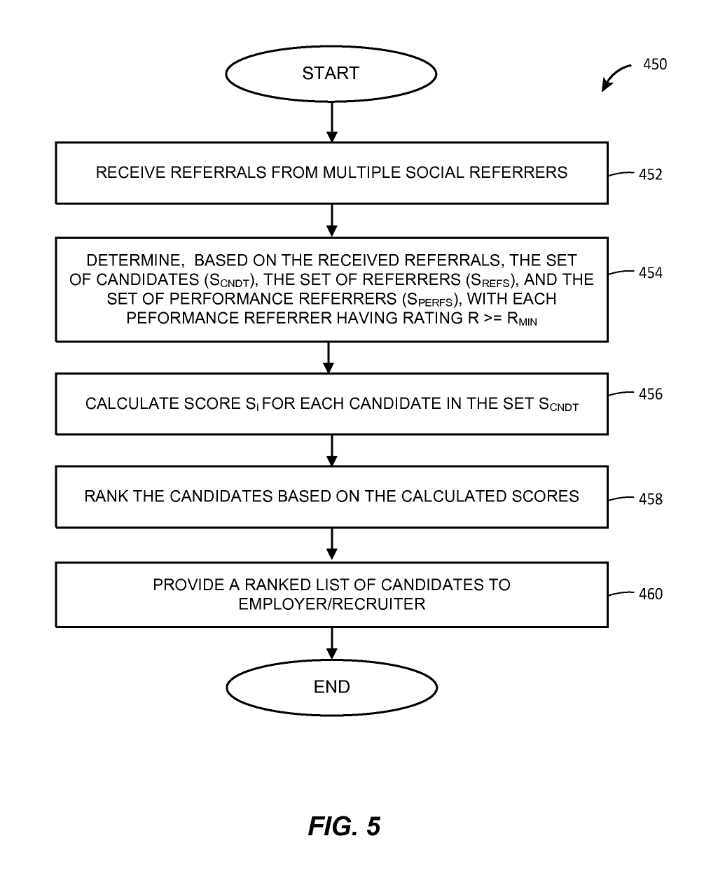

Next, FIG. 5 illustrates an example method 450 for generating a ranked list of candidates using the method of FIG. 4 or a similar method to generate scores for individual candidates. Similar to the method 400, the method 450 can be implemented in the referral ranking module 62 of FIG. 1 and/or as part of the candidate ranking logic 312 of FIG. 2.

The method 450 begins at block 452, where referrals from multiple social referrers are received. Next, a set of unique candidates S_{CNDT} is determined. Thus, if ten social referrers refer six different candidates, the set S_{CNDT} will include six elements. Similarly, a set of unique referrers S_{REFS} is determined because in some scenarios, referrers may be permitted to recommend more than one candidate. Also, a set of unique performance referrers S_{PERFS} is determined, with R≧R_{MIN}.

At block 454, a score S, for each candidate in the set S_{CNDT} is calculated according to the method 400, for example. The candidates in the set S_{CNDT} are ranked according to the calculated scores at block 456. The ranked candidate list is provided to the employer or recruiter at block 460. In some implementations, only top N results are selected from the set S_{CNDT} for presentation to the employer or recruiter.

### Example Techniques for Updating Individual Metrics

Example techniques for generating updated numeric metrics for referrers, candidates, and employers are discussed next. In particular, FIG. 6 is a flow diagram of an example method 480 for updating one or several quantitative metrics for a user based on feedback received in connection with a candidate referral, which can be implemented in the referral ranking module 62, for example.

At block 482, an indication that a social referrer referred a candidate is received. Feedback regarding the candidate is received from the employer or recruiter at block 484, and an indication of the candidate's progress with respect to the job referral is received at block 486. For example, the employer can operate the review candidate function 172 to provide initial feedback after reviewing the referral, and operate the interview and re-rating feedback function 174 to provide feedback after interviewing the candidate. A new score for the social referrer is calculated at block 488 in view of the data received at blocks 484 and 486, and the new score is saved in the referrer-specific database record.

For additional clarify, FIG. 7 illustrates a combined block/data flow diagram 500 that illustrates example events that trigger potential or actual updates to referrer, referral, and employer ratings, which can occur in the system of FIG. 1 during operation. Some of the events of FIG. 7 closely correspond to the functions depicted in FIG. 2 (e.g., the accept referral event 502 closely corresponds to the result of the candidate executing the accept referral function 258B).

As illustrated in FIG. 7, the accept referral event 502 can trigger a candidate review and rating event 506, an interview and rating event 508, a no interview event 510, a decision to hire even 512, and a decision to not hire event 514. When the referral is declined or ignored (event 504, which may be an explicit rejection or a timeout, for example), no rating is applied (event/decision 515). The candidate review and rating event 506 triggers an initial potential rating captured event 520, when the employer's initial rating of the referral and/or the candidate is recorded, an initial potential rating captured event 530, where the initial rating of the candidate is recorded for the purposes of eventually adjusting the metrics of the social referrer, and the overall average rating adjusted event 560, where the average rating for the employer is adjusted. More particularly, the referral system may determine how particular employers tend to rate candidates so as to make corrections to candidate and referrer scores, when necessary.

The no interview event 510 triggers a default to initial rating event 516. In other words, if the employer decides to not interview the candidate after the initial rating of the candidate, the initial rating assigned after the initial rating event 516 is used. On the other hand, the no decision to not hire event 514 triggers the default to an interview rating event 517. In this case, when the employer decides to pass on the candidate after interviewing, the rating assigned after the interview is retained for the candidate and the referrer.

As further illustrated in FIG. 7, the interview and rating event 508 triggers a potential rating replaced with interview rating event 522 and a similar potential referral replaced with interview rating event 532 to adjust the ratings for the referral/candidate and the referrer, respectively. The decision to hire event 512 triggers the potential rating replaced with 5 stars event 524 and the referral rating replaced with 5 stars event 534. In other implementations, any other suitable value can be assigned to the rating (e.g., a different number of stars or a numerical score of 10.0).

Following one or more of the events 520, 522, an 524, a final rating averaged with the overall rating event 526 is triggered, where the overall rating for the submitted referral and/or the candidate identified in the referral is calculated in view of the employer rating and the progress of the interviewing/hiring process. Similarly, a final rating averaged with the overall rating event 536 is triggered after one or more of the events 530, 532, and 534. The event 536 corresponds to the overall rating for referred being calculated in view of the employer rating and the progress of the interviewing/hiring process.

Thus, the star rating of a social referrer can be a numeric metric that reflects the success and feedback related to his or her past referrals. The star rating can be calculated based on the success rate of past referrals submitted by the referring registered user (which in turn can be calculated based on interview numbers, hire numbers, etc.), the quality of feedback related to the referring registered user (which can come from employers), or both. Moreover, star ratings for specific categories and/or sub-categories can be calculated for a social referrer over appropriate subsets of the past referrals (e.g., referrals in graphic design, referrals in wedding planning, etc.). Thus, a social referrer with a relatively high overall star rating can nevertheless have an average star rating for an industry category, and a relatively low star rating for an industry sub-category.

### Prediction and Automation Techniques

Referring back to FIGS. 1 and 2, the referral server 12 in some implementations of the referral system can identify best-guess candidates for a job being reviewed by the referrer, and/or highlight jobs for the referrer if it appears likely the referrer may have a referral. Thus, an active referrer can access a description of a recently posted job via the dashboard function 204, and the referral server 12 can automatically suggest whom the referrer may wish to refer. As a more specific example, a referrer may have recommended a certain potential candidate for a job teaching music in the past, and the referral server 12 may automatically remind the referrer that the same candidate also may be a good match for a similar job the referrer is currently reviewing. If the referrer does not appear to have read or noticed this job description, the referral server 12 may automatically generate a message for the referrer, suggesting that the referrer appears to know suitable potential candidates.

Further, the referral server 12 can allow potential candidates to indicate interest in a certain job via the dashboard function 256, and automatically identify referrers who may be able to refer the candidate based on past referrals, for example. Still further, the referral server 12 in some implementations can automatically process a new job description, identify potential candidates who may not even be aware of the job opportunity based on industry category, sub-category, tags indicating required skills, years of experience required, etc., determine whether these potential candidates are likely to be get high scores if referred (e.g., by projecting that a referrer who previously referred this person for a similar job would do so again with a certain probability, such as 80%, and calculating projected candidate score as if the referrer already submitted the referral), and present these potential candidates to the employer. In this manner, the referral system can allow the employer to quickly and efficiently identify good potential candidates even when these potential candidates or the corresponding potential referrers have not yet acted upon the job listing or, conversely, quickly eliminate unsuitable candidates even before the corresponding referrals are received.

### General Comments

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, at least some of the operations may be performed by a group of computers (as examples of machines including processors), these operations being accessible via a network (e.g., the Internet) and via one or more appropriate interfaces (e.g., application program interfaces (APIs).)

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for a system and a process for automatically generating ranked job referrals through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for automatically generating ranked candidate referrals for employment opportunities, the method comprising:
providing, by one or more processors via a communication network, a data record descriptive of an employment opportunity submitted by a potential employer, to a plurality of registered users;
receiving, by the one or more processors via the communication network, a plurality of referrals from at least several of the plurality of registered users, the plurality of referrals indicating a multiplicity of candidates;
retrieving, by the one or more processors from an electronic database, numeric metrics related to the referring registered users, including retrieving, for each referring registered user, (i) a first numeric metric indicative of success rate of past referrals submitted by the referring registered user and (ii) a second numeric metric indicative of quality of feedback related to the referring registered user;
calculating, by the one or more processors, respective scores for each of the multiplicity of candidates based at least on the retrieved numeric metrics;
ranking, by the one or more processors, the multiplicity of candidates based on the calculated scores to generate a ranked list; and
providing, by the one or more processors via the communication network, a data record including the ranked list to the potential employer.

2. The method of claim 1, further comprising:
determining, by the one or more processors, an industry category to which the employment opportunity belongs; and
generating respective multipliers for the first numeric metric and the second numeric metric based at least in part on the determined industry category;
wherein calculating the respective scores for each of the multiplicity of candidates is further based on the multipliers applied to the first numeric metric and the second numeric metric.

3. The method of claim 1, further comprising:
determining, by the one or more processors, an industry category and an industry sub-category to which the employment opportunity belongs;
calculating, by the one or more processors for each of the multiplicity of candidates (i) a first aggregate rating metric based on past referrals related to the industry category, of the referring registered users that refer the candidate, and (ii) a second aggregate rating metric based on past referrals related to the sub-industry category, of the referring registered users that refer the candidate;
wherein calculating the respective scores for each of the multiplicity of candidates includes using the respective first aggregate rating metric and the second aggregate metric.

4. The method of claim 1, wherein calculating the respective scores for each of the multiplicity of candidates includes:
retrieving a first multiplier and a second multiplier from the electronic database, and
applying the first multiplier to the first aggregate rating metric and the second multiplier to the second aggregate metric when calculating the respective scores, so as to weigh the first aggregate rating metric differently from the second aggregate metric.

5. The method of claim 1, further comprising:
determining, by the one or more processors for each of the multiplicity of candidates, a respective number of the referring registered users that refer the candidate and whose first numeric metric exceeds a predefined threshold;
wherein calculating the respective scores for each of the multiplicity of candidates is further based on the determined number.

6. The method of claim 1, wherein the first numeric metric is indicative of a total number of past job interviews resulting from referrals by the referring registered user; and wherein retrieving the numeric metrics further includes:
retrieving, by the one or more processors for each referring registered user, a third numeric metric indicative of a total number of hires resulting from referrals by the referring registered user.

7. The method of claim 1, further comprising:
receiving, by the one or more processors, feedback regarding one or of the multiplicity of candidates, from the potential employer; and
updating, by the one or more processors, the first numeric metric for at least one of the referring registered users.

8. The method of claim 7, wherein receiving the feedback includes receiving indication of one or more of the multiplicity of candidates being hired, and/or one or more of the multiplicity of candidates obtaining an interview.

9. A computing system comprising:
one or more databases implemented in a non-transitory computer-readable medium and storing a plurality of data records corresponding to a plurality of registered users, wherein each data record for a social referrer includes a numeric metric indicative of success rate of past referrals submitted by the registered user;
a network interface to exchange data with client devices; and
a processing hardware configured to:
receive a description of an employment opportunity from a potential employer,
provide the description of the employment opportunity to the plurality of registered users,
receive a plurality of referrals related to the employment opportunity from at least several of the plurality of registered users, wherein the plurality of referrals indicates a multiplicity of candidates,
retrieve the respective numeric metrics for referring users from the one or more databases, including a numeric metric indicative of a rating assigned to the referring user based on his or her past referrals,
ranking the multiplicity of candidates using the numeric metrics to generate a ranked list, and
provide the ranked list to the potential employer.

10. The computing system of claim 9, wherein the processing hardware is further configured to:
generate, for each of the referring users, the numeric metric based on (i) a success rate of past referrals submitted by the referring registered user, wherein the success rate is related to a number of interviews and/or hires, and (ii) quality of feedback related to the referring registered user.

11. The computing system of claim 9, wherein the processing hardware is further configured to:
determine an industry category and an industry sub-category to which the employment opportunity belongs;
calculate, for each of the multiplicity of candidates, (i) a first aggregate rating metric based on past referrals related to the industry category, of the referring registered users that refer the candidate, and (ii) a second aggregate rating metric based on past referrals related to the sub-industry category, of the referring registered users that refer the candidate;
wherein to calculate the respective scores for each of the multiplicity of candidates, the processing hardware uses the respective first aggregate rating metric and the second aggregate metric.

12. The computing system of claim 9, wherein the processing hardware is further configured to:
determine, for each of the multiplicity of candidates, a respective number of the referring registered users that refer the candidate and whose first numeric metric exceeds a predefined threshold;
wherein to calculate the respective scores for each of the multiplicity of candidates, the processing hardware uses the determined number.

13. The computing system of claim 9, wherein the processing hardware is further configured to:
receive feedback regarding one or of the multiplicity of candidates, from the potential employer; and
update the numeric metric for at least one of the referring registered users.

14. The computing system of claim 13, wherein to receive the feedback, the processing hardware is further configured to:
receive indication of one or more of the multiplicity of candidates being hired, and/or one or more of the multiplicity of candidates obtaining an interview.

15. A non-transitory computer-readable medium storing thereon instructions that, when executed on one or more processors, cause a computing device to:
provide a data record descriptive of an employment opportunity submitted by a potential employer, to a plurality of registered users;
receive, via the communication network, a plurality of referrals from at least several of the plurality of registered users, the plurality of referrals indicating a multiplicity of candidates;
obtain, from an electronic database, numeric metrics related to the referring registered users, including, for each referring registered user, a numeric metric indicative of success rate of past referrals, wherein the success rate corresponds to at least one of (i) a number of past interviews or (ii) a number of hires resulting from referrals by the referring registered user;
calculate respective scores for each of the multiplicity of candidates based at least on the obtained numeric metric;
rank the multiplicity of candidates based on the calculated scores to generate a ranked list; and
provide, via the communication network, a data record including the ranked list to the potential employer.

16. The computer-readable medium of claim 15, wherein the metric is a first metric, and where the instructions further cause the computing device to:
obtain, as part of the numeric metrics, a second numeric metrics indicative of quality of feedback related to the referring registered user, wherein the feedback is collected from employers.

17. The computer-readable medium of claim 15, wherein the instructions further cause the computing device to:
determine an industry category and an industry sub-category to which the employment opportunity belongs;
calculate, for each of the multiplicity of candidates (i) a first aggregate rating metric based on past referrals related to the industry category, of the referring registered users that refer the candidate, and (ii) a second aggregate rating metric based on past referrals related to the sub-industry category, of the referring registered users that refer the candidate;
wherein to calculate the respective scores for each of the multiplicity of candidates, the instructions cause the computing device to use the respective first aggregate rating metric and the second aggregate metric.

18. The computer-readable medium of claim 15, wherein the instructions further cause the computing device to:
determine, for each of the multiplicity of candidates, a respective number of the referring registered users that refer the candidate and whose first numeric metric exceeds a predefined threshold;
wherein to calculate the respective scores for each of the multiplicity of candidates, the instructions cause the computing device to use the determined number.

19. The computer-readable medium of claim 15, wherein the instructions further cause the computing device to:
receive feedback regarding one or of the multiplicity of candidates, from the potential employer; and
update the numeric metric for at least one of the referring registered users.

20. The computer-readable medium of claim 19, wherein to receive the feedback, the instructions further cause the computing device to:
receive indication of one or more of the multiplicity of candidates being hired, and/or one or more of the multiplicity of candidates obtaining an interview.
